(19) United States
(12) Patent Application Publication
(10) Pub. No.: US 2011/0161866 A1
(43) Pub. Date: Jun. 30, 2011

(54) METHOD AND APPARATUS FOR MANAGING NOTIFICATIONS FOR A LONG SCROLLABLE CANVAS

(75) Inventor: Roope Aleksi RAINISTO, Helsinki (FI)

(73) Assignee: NOKIA CORPORATION, Espoo (FI)

(21) Appl. No.: 12/648,382

(22) Filed: Dec. 29, 2009

(51) Int. Cl. G06F 3/048

(52) U.S. Cl. 715/785; 715/808

(57) ABSTRACT

A method, apparatus, user interface and computer program product for detecting an update to a widget on a content page, at least a portion of the content page being presented in a viewable display area of a screen of the device, determining that the updated widget is not within the viewable display area of the screen of the device, and providing a highlighted notification at an edge of the viewable display area, the edge of the viewable display area corresponding to a direction of the updated widget on the page.

### TECHNICAL FIELD

The aspects of the disclosed embodiments generally relate to mobile communication devices, and in particular to managing content displayed on a mobile communication device.

### BACKGROUND

User interfaces of communication devices are generally based on the push and pull of information. “Pull” generally means that users actively use the device to obtain information. “Push” generally means that the device receives new or updated information, and that this new information is “pushed” to the user. The “push” of information is generally carried out in a manner that does not distract from the primary (pull) type of device usage.

One issue with mobile communication devices is the limited amount of screen space. Due to the smaller size of such devices, all of the content of a view may not fit within the confines of the device screen at any one time. Users can typically scroll through the content, using for example the device keys, scroll bars or kinetically scrolling, i.e. flicking the page forward.

A page in a view can include multiple elements, and can include a combination of static elements and dynamic elements. Static element generally include data that does not change, or is not subject to “push” type of information and updates. Dynamic elements generally include interactive elements, such as for example “widgets.” Widgets generally include interactive virtual tools that provide single-purpose services such as showing the user the latest news, the current weather, the time, a calendar, among other things. Widgets serve both the push and pull type usage for the user. A widget type page is generally a long page where the user can freely add any number of widgets to the page.

Typically, to view a widget on a widget type page, the user will scroll to the page position to find the widget they are looking for. Once the desired widget is found, the widget can be selected, “clicked-on” to go to a full view or web view. For example, in an email inbox widget, clicking on it launches the email application for a full view of the inbox.

Widgets are also used to provide notifications to users. For example, with a Facebook™ widget, when the Facebook™ feed is updated, the user will likely desire to obtain further information on the update.

Certain types of messaging applications, such as calls, short message service (SMS) provide ways to handle notifications. In some instances these call type notifications can be obtrusive. However, it may not be desirable to provide those types of notifications for widget type page updates. For example, a user may not wish to be disturbed by a call style notification each time the Facebook™ feed updates itself. However, the user would still want to be made aware of the update.

However, in a mobile communication device, or other such device where the display size is limited, it may not be possible to view all of the widgets at the same time. Thus, if a widget is updated with new information, and that widget is not presently displayed on the screen, the update may not be immediately noticeable, until the user scrolls the pages.

Accordingly, it would be desirable to address at least some of the problems identified above.

### SUMMARY

Various aspects of examples of the invention are set out in the claims.

According to a first aspect a method includes detecting an update to a widget on a content page, at least a portion of the content page being presented in a viewable display area of a screen of the device, determining that the updated widget is not within the viewable display area of the screen of the device, and providing a highlighted notification at an edge of the viewable display area, the edge of the viewable display area corresponding to a direction of the updated widget on the page.

According to a second aspect, an apparatus includes a processor configured to detect an update to a widget on a content page, at least a portion of the content page being presented in a viewable display area of a screen of the device, determining that the updated widget is not within the viewable display area of the screen of the device, and providing a highlighted notification at an edge of the viewable display area, the edge of the viewable display area corresponding to a direction of the updated widget on the page.

According to another aspect, a computer program product has a computer-readable medium bearing computer code embodied therein for use with a computer, the computer program code including code for detecting, in a mobile communication device, an update to a widget on a content page, at least a portion of the content page being presented in a viewable display area of a screen of the device, code for determining that the updated widget is not within the viewable display area of the screen of the device, and code for providing a highlighted notification at an edge of the viewable display area, the edge of the viewable display area corresponding to a direction of the updated widget on the page.

### BRIEF DESCRIPTION OF THE DRAWINGS

For a more complete understanding of the example embodiments, reference is now made to the following descriptions taken in connection with the accompanying drawings, in which:

FIG. 1 is a block diagram of an exemplary device incorporating aspects of the disclosed embodiments;

FIGS. 2A-2E are screenshots illustrating aspects of the disclosed embodiments;

FIGS. 3A-3B are flowcharts of exemplary processes illustrating aspects of the disclosed embodiments;

FIG. 4 shows an exemplary device that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE DRAWINGS

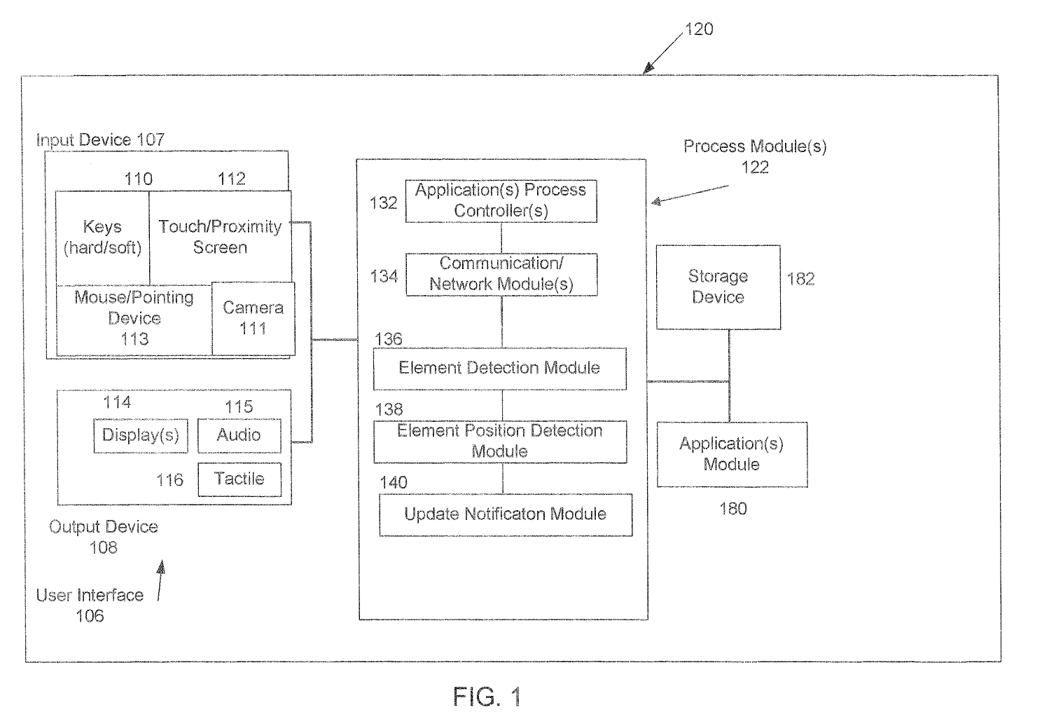

Example embodiments of the present application and its potential advantages are understood by referring to FIGS. 1-6 of the drawings. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments are generally directed to providing a viable, but non-obtrusive mechanism for indicating updates to page elements and utilizing screen edges for soft notifications. When a notification arrives related to an update to a page element that is not currently visible on the screen, a notification can be provided along an edge of the screen that is in the same direction as the corresponding page element.

FIG. 1 illustrates one embodiment of an exemplary communication device or apparatus 120 that can be used to practice aspects of the disclosed embodiments. The communication device 120 of FIG. 1 generally includes a user interface 106, one or more process module(s) 122, one or more application module(s) 180, and one or more storage device(s) 182. In alternate embodiments, the device 120 can include other suitable systems, devices and components that allow for utilizing screen edges to provide notifications related to page element updates. The components described herein are merely exemplary and are not intended to encompass all components that can be included in, or used in conjunction with the device 120. The components described with respect to the device 120 will also include one or more processors or computer program products to execute the processes, methods, sequences, algorithms and instructions described herein.

The user interface 106 of the device 120 generally includes input device(s) 107 and output device(s) 108. The input device(s) 107 are generally configured to allow for the input of data, instructions, information gestures and commands to the device 120. The input device 107 can include one or a combination of input devices such as, for example, but not limited to, keys or keypad 110, a touch sensitive area or touch screen 112 or proximity screen, and a mouse or pointing device 113. In one embodiment, the keypad 110 can be a soft key or other such adaptive or dynamic device of a touch screen 112. The input device 107 can also be configured to receive input commands remotely or from another device that is not local to the device 120. The input device 107 can also include camera device(s) 111 or other such image capturing system(s).

The output device(s) 108 is generally configured to allow information and data to be presented to the user and can include one or more devices such as, for example, a display 114, audio device 115 and/or tactile output device 116. In one embodiment, the output device 108 can also be configured to transmit information to another device, which can be remote from the device 120. While the input device 107 and output device 108 are shown as separate devices, in one embodiment, the input device 107 and output device 108 can comprise a single device, such as for example a touch screen device, and be part of and form, the user interface 106. For example, in one embodiment where the user interface 106 includes a touch screen device 112, the touch screen 112 can also serve as an output device as part of the display 114, providing functionality and displaying information, such as keypad or keypad elements and/or character outputs in the touch sensitive area of the display 114. While certain devices are shown in FIG. 1, the scope of the disclosed embodiments is not limited by any one or more of these devices, and alternate embodiments can include or exclude one or more devices shown.

The process module 122 is generally configured to execute the processes and methods of the aspects of the disclosed embodiments. The process module 122 can include hardware, software and application logic, or a combination thereof. As described herein, the process module 122 is generally configured to detect an update to a page element, and determine whether the page element is in the visible portion of the display. The process module 122 is configured to activate or generate a notification that utilizes the screen edges.

In one embodiment, the process module 122 can include a page element update detection module 136. The page element update module 136 is generally configured to detect a content or information update with respect to the page element. In one embodiment, the page element is a widget. In alternate embodiments the page element can be any suitable element that is capable of being updated.

In one embodiment, the process module 122 can also include a page element position detection module 138. The page element position detection module 138 is generally configured to determine whether an updated page element is within the viewable area or region of the display 114. If the updated page element is not within the viewable region of the display 114, the page element position module 138 can also be configured to determine a direction to the updated page element, relative to the viewable area or region of the display 114.

The process module 122 can also include a notification module 140. In one embodiment, the notification module 140 will generally be configured to provide a notification when an update to a page element is detected. When the page element is visible on the screen, the notification can be a visible highlight that surrounds the page element. When the page element is not visible on the screen, the notification can be a visible highlight along one edge of the visible area of the display. In one embodiment, the notification module 140 is configured to use the page element position information and provide the notification along the edge of the visible area of the display that is in the direction of the updated page element. The notification module 140 can be configured to provide any suitable notification. Examples of the notifications can include, but are not limited to a visual highlight, a pulsating glow, a graphic icon or image.

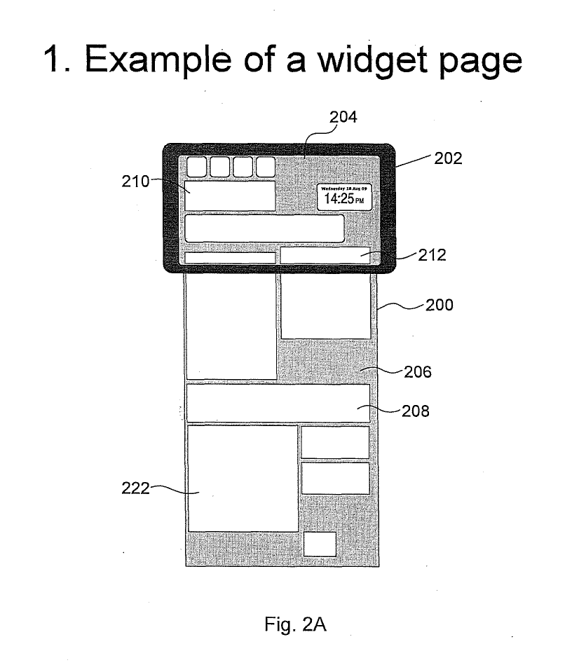

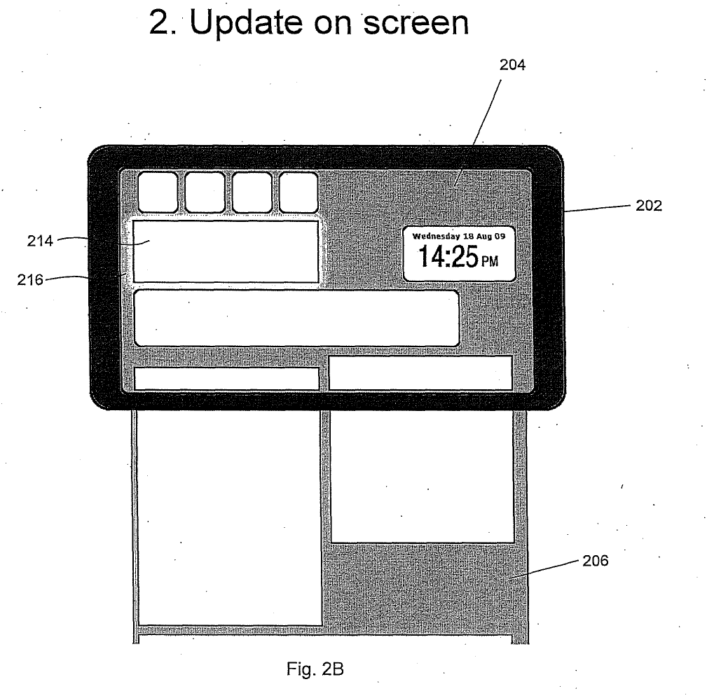

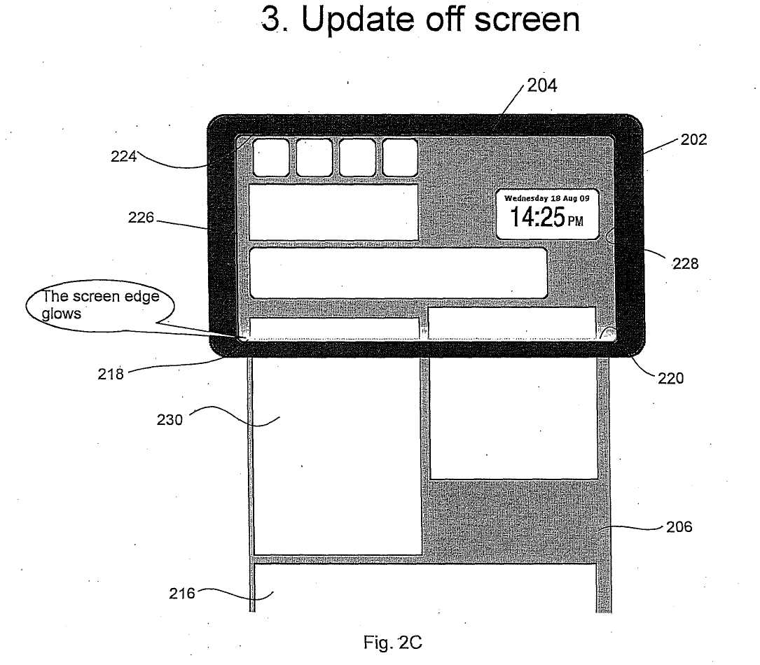

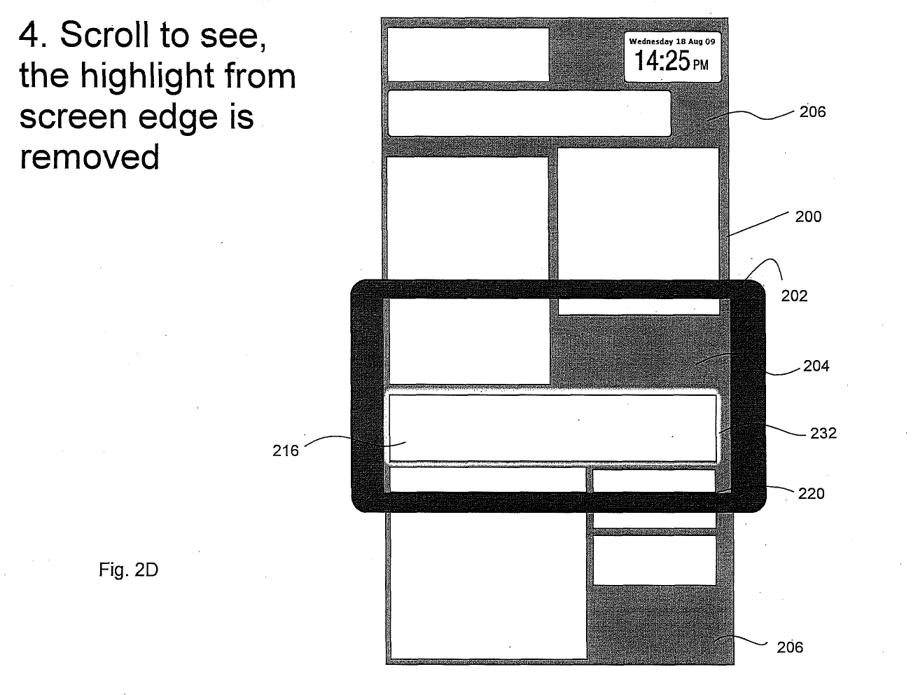

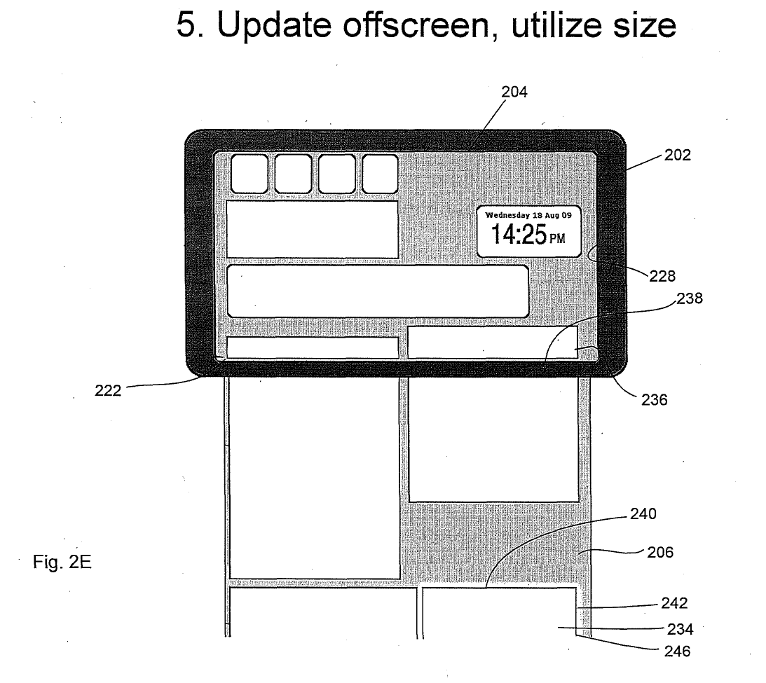

FIG. 2A illustrates one example of a widget page 200. The widget page 200 includes a portion 204 that is within the visible display area of the screen 202 as well as a portion 206 that is in the non-visible display area. Generally, a user can use the scroll or other suitable controls of the device to move the widget page 200 up and down, so as to bring certain elements into the visible or viewable display area 204 and move other elements into the non-visible or non-viewable display area 206.

The widget page 200 can include multiple elements, such as elements 208, 210 and 212. Element 208 is shown in the non-visible portion 206 of the page 200, element 210 is in the visible display area 204 of the page 200, while element 212 includes a portion within the visible display area 204 and another portion within the non-visible display area 206.

FIG. 2B illustrates an embodiment where a page element 214, within the visible display area 204, is updated. As shown in FIG. 2B, a notification 216 is provided in the form of a highlight around the page element 214. In alternate embodiments, the notification 216 can be in any suitable form that provides a visible but non-obtrusive mechanism for indicating updates to page elements.

FIG. 2C illustrates an embodiment where a page element 216 that is in the non-visible display area 206 is updated. In this example, a notification 218 is provided along the edge 220 of the screen 202. In one embodiment, the notification 218 is a highlighted strip or element along the edge 220. In this example, the notification 218 is configured to appear to be brighter, or glow, in comparison to the other elements in the visible display area 204. Although in FIG. 2C, the notification 218 appears to be contiguous with element 230, in alternate embodiments, the notification 218 does not have to be adjacent to any other element.

In one embodiment, the notification 218 will be disposed on an edge of the screen 202 that corresponds to the direction of the updated element. In the example shown in FIG. 2C, the notification 218 is along edge 220, which is in the direction of the updated element 216. Thus, when the user views the notification 218 along edge 220, the user will know to scroll in that direction in order to bring or move the updated element within the visible display area 204. If the notification 218 were disposed along any of the other side or edges 224, 226 and 228 of the screen 202, the user would scroll the visible display area 204 in the respective direction to be able to view the updated element. As will be generally understood, scrolling on a display 114 can generally occur in three dimensions, side-to-side, top-to-bottom, and diagonally.

FIG. 2D illustrates an embodiment, where the widget or element page 200 has been scrolled after a notification, such as notification 218 in FIG. 2C is presented. As the scrolling causes the updated element 216 to appear in the visible display area 204. In one embodiment, as the updated element 216 moves into the visible display area 204, the notification 218 from the screen edge 220 is removed. As shown in the example of FIG. 2D, a notification 232 appears around the updated element 216. Although the notification 232 is described as being around the updated element 216, in alternate embodiments any suitable notification can be used. For example, the notification 232 may include causing all of the updated element to glow or pulse as is described herein.

In one embodiment, the notification 232 will be visible for as long as the user keeps the updated element in the visible display area 204. If the user scrolls the screen 202 so that the element 234 moves completely off the visible display area 204, and then scrolls the screen 202 back to the previous position, the notification will no longer be visible. In alternate embodiments, any suitable method of removing notification 232 can be used, including for example, a time-out period after the updated element 234 is moved into the visible display area 204.

FIG. 2E illustrates an embodiment, where the size of the notification 236 is illustrative of a size of the updated element. The elements of the widget page 200 are generally of different shapes and sizes. The notification along the edge 222 does not have to occupy the entirety of the edge. Rather, the notification 236 can occupy only a portion 238 of the edge 222, where the size or length of the portion 238 corresponds to a respective dimension of the updated element 234. For example, the length of the edge 238 of the notification 236 will generally correspond to the length of the corresponding top edge 240 of the updated element 234. Similarly, if the notification 236 were along edge 228, the length 238 of the notification 236 could be similar to the dimension or length 242 of the corresponding edge 246 of the updated element 234. In one embodiment, if there are two separate items below the current screen position 204 that have been updated, the notification or screen edge glow visualization 236 can be two overlayed elements. Alternatively, the notification 236 can be positional. For example, if the updated element 234 is a small icon in the right hand side of the display area 204, the size and position of the notification 236 along the screen edge 238 can match the size of the updated element 234.

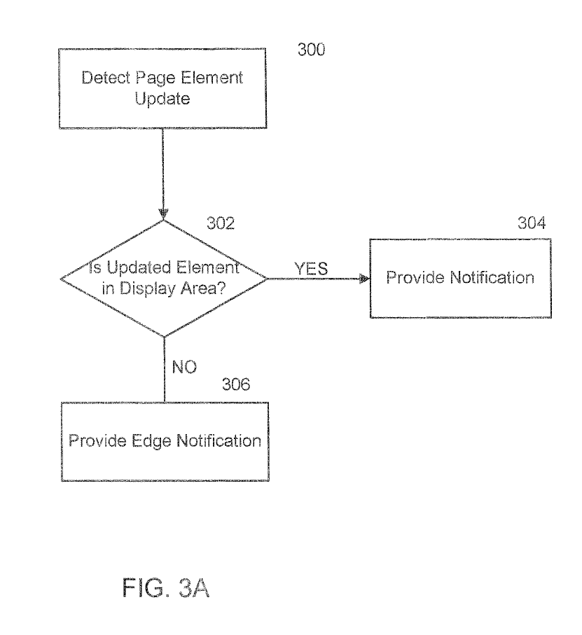

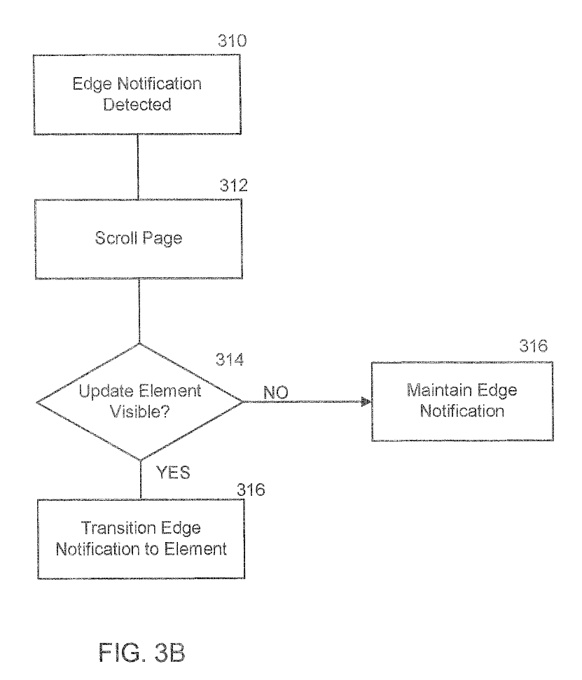

FIG. 3 is a flowchart illustrating one embodiment of a process flow incorporating aspects of the disclosed embodiments. An update 300 to a page element is detected. It is determined 302 whether or not the updated element is within the visible or viewable display area. If the updated page element is within the viewable display area, then a notification is provided 304 in conjunction with the updated page element. In one embodiment this notification can comprise a visual highlight around, or in conjunction with, the updated page element.

If the updated page element is not within the viewable display area, then a notification is provided 306 along an edge of the visible display area of the screen. In one embodiment, the notification is provided along the edge of the visible display area that corresponds to the direction of the updated page element on the widget or element page. The notification can be any suitable visual indicator. In one embodiment, the notification is a soft pulsating bar or image, or a glowing image or highlight along the edge of the visible display area.

Referring to FIG. 3B, if an edge notification is present 310 and the widget page is scrolled 312, it is determined 314 whether the updated element is within the viewable display area. If the updated element is not within the viewable display area, then the edge notification is maintained 316.

If the updated element is within the viewable display area, a transition 318 occurs where the screen edge highlight is smoothly transformed to the visible highlight around or in conjunction with the updated element. The visible highlight generally comprises any suitable visual attribute, such as a pulsating glow. In a situation where more the one page element is updated, the notifications for each page element can be differentiated in any suitable manner. For example, different colors of highlights, shapes or images can be used.

The application process controller 132 shown in FIG. 1 is generally configured to interface with the application module 180 and execute applications processes with respect to the other components and modules of the device 120. In one embodiment the application module 180 is configured to interface with applications that are stored either locally to or remote from the device 120. The application module 180 can include any one of a variety of applications that may be installed, configured or accessible by the device 120, such as for example, contact applications and databases, office and business applications, media player applications, multimedia applications, web browsers, global positioning applications, navigation and position systems, and map applications. The application module 180 can also include a voice recognition system that includes a text-to-speech module that allows the user to receive and input voice commands, prompts and instructions, through a suitable audio input device. In alternate embodiments, the application module 180 can include any suitable application that can be used by or utilized in the processes described herein.

The communication module 134 shown in FIG. 1 is generally configured to allow the device 120 to receive and send communications and data including for example, telephone calls, text messages, push to talk cellular service, location and position data, navigation information, chat messages, multimedia messages, video and email. The communications module 134 is also configured to receive information, data and communications from other devices and systems or networks, such as for example, the Internet. In one embodiment, the communications module 134 is configured to interface with, and establish communications connections with other services and applications using the Internet.

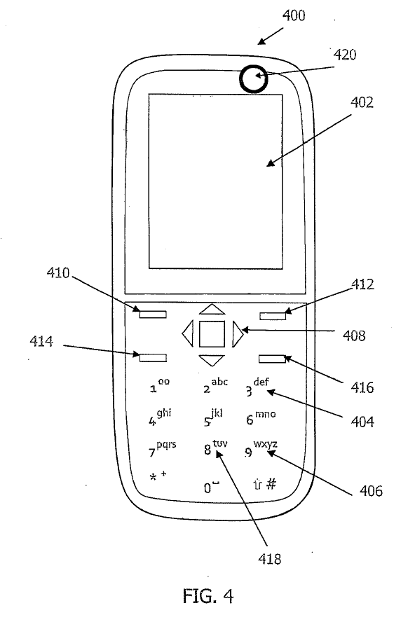

An example of a device on which aspects of the disclosed embodiments can be practiced is illustrated in FIG. 4. The device is merely exemplary and are not intended to encompass all possible devices or all aspects of devices on which the disclosed embodiments can be practiced. The aspects of the disclosed embodiments can rely on very basic capabilities of devices and their user interface.

FIG. 4 illustrates one example of a device 400 that can be used to practice aspects of the disclosed embodiments. As shown in FIG. 4, in one embodiment, the device 400 has a display area 402 and an input area 404. The input area 404 is generally in the form of a keypad 406. In one embodiment the input area 404 is touch sensitive. As noted herein, in one embodiment, the display area 402 can also have touch sensitive characteristics. Although the display 402 of FIG. 4 is shown being integral to the device 400, in alternate embodiments, the display 402 may be a peripheral display connected or coupled to the device 400.

In one embodiment, the keypad 406, in the form of soft keys, may include any suitable user input functions such as, for example, a multi-function/scroll key 408, soft keys 410, 412, call key 414, end key 416 and alphanumeric keys 418.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, referring to FIG. 4, the device 400 can include an image capturing device such as a camera 420. The device 400 may also include other suitable features such as, for example a loud speaker, tactile feedback devices or connectivity port. The mobile communications device may have a processor or other suitable computer program product connected or coupled to the display for processing user inputs and displaying information on the display 402. A computer readable storage device, such as a memory may be connected to the processor for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the device 120 of FIG. 1 may be for example, a personal digital assistant (PDA) style device. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display and supported electronics such as a processor(s) and memory(s). In one embodiment, these devices will be Internet enabled and include GPS and map capabilities and functions.

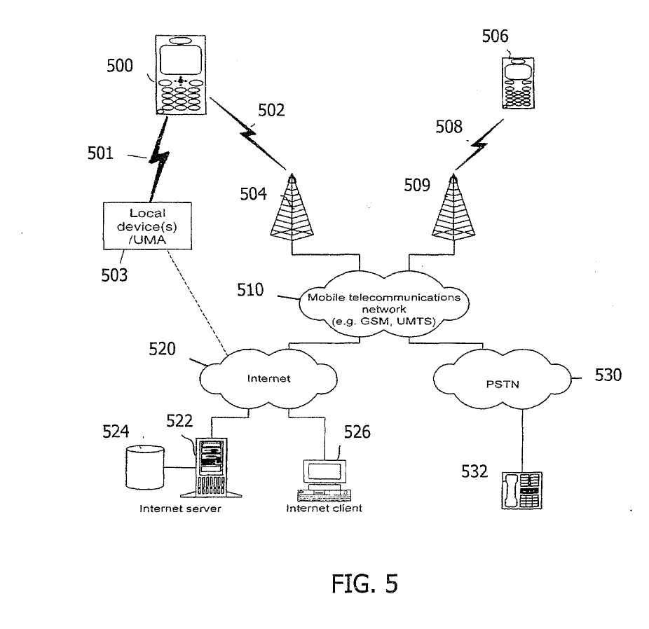

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an Internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the communication module 134 of FIG. 1 is configured to interact with, and communicate with, the system described with respect to FIG. 5.

Without in any way limiting the scope, interpretation, or application of the claims appearing below, a technical effect of the one or more example embodiments disclosed herein is providing a visible, but non-obtrusive notification for indicating updates to page elements. If the updated page element is not within a visible viewing area of the display, in one embodiment, the notification is provided along an edge of the visible viewing area in a manner that is indicative of a scrolling direction towards the updated element. The notification can also be sized to correspond to a size of the updated page element in order to provide the user with some information about the updated element. In one embodiment, the notification could include graphics, text or other suitable identifiers that provides some indication as to the source of the notification, or which page element has been updated.

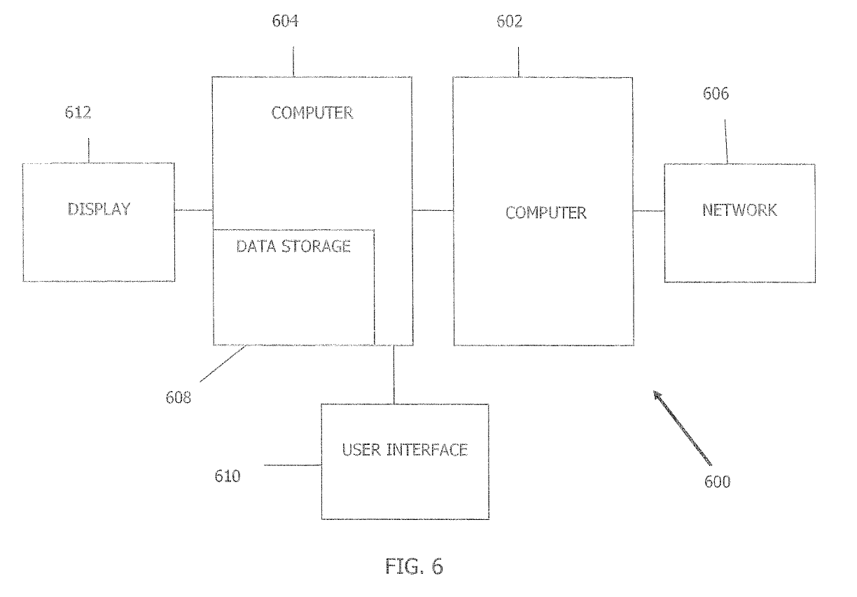

The aspects of the disclosed embodiments may be implemented in software, hardware, application logic or a combination of software hardware and application logic. The software, application logic and/or hardware may reside on one or more computers as shown in FIG. 6. If desired, part of the software, application logic and/or hardware may reside on one computer 602, while part of the software, application logic and/or hardware may reside on another computer 604. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer readable storage medium that may be any media or means that can contain or store the instructions for use by or in connection with an instruction execution system, apparatus or device, such as a computer.

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practice aspects of the invention. The apparatus 600 can include computer readable program code means embodied or stored on a computer readable storage medium for carrying out and executing the process steps described herein. In one embodiment the computer readable program code is stored in a memory(s) of the device. In alternate embodiments the computer readable program code can be stored in memory or other storage medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is configured to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor(s) for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments generally provide a viable, but non-obtrusive mechanism for indicating updates to page elements and utilizing screen edges for soft notifications. If a notification or page element panel is not visible on a screen when a notification arrives, then a soft pulsating reminder in the form of a glow or pulsation can be shown at an edge of the display in the direction towards where the updated element is present in the element page or panel. The notification is generally in conjunction with an update to a page element. If the page element is within the viewable display area, a visual notification can be provided in conjunction with the updated page element. The visualization scales up to indicate one or multiple updates in elements. The indications are direct and intuitive, and the highlight or notification can be shown in conjunction with the element or then transferred to the screen edge. When scrolling the page, the screen edge highlight can be smoothly transformed to a visible highlight around or in conjunction with the updated element. It is noted that the embodiments described herein can be used individually or in any combination thereof. If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the invention as defined in the appended claims.

What is claimed is:

1. A method comprising:
detecting, in a mobile communication device, an update to a widget on a content page, at least a portion of the content page being presented in a viewable display area of a screen of the device;
determining that the updated widget is not within the viewable display area of the screen of the device; and
providing a highlighted notification at an edge of the viewable display area, the edge of the viewable display area corresponding to a direction of the updated widget on the page.

2. The method of claim 1 further comprising determining that the updated widget is within the viewable display area of the screen, and providing the highlighted notification around a perimeter of the updated widget.

3. The method of claim 1 further comprising that the highlighted notification on the edge of the viewable display area has a dimension along the edge corresponding to a respective dimension of a corresponding side of the updated widget.

4. The method of claim 1 further comprising that a position of the highlighted notification along the edge corresponds to a position of the updated widget on the page.

5. The method of claim 1 further comprising scrolling the screen in the direction of the updated widget to remove the highlighted notification from the edge of the viewable display area.

6. The method of claim 1 wherein the highlighted notification is a soft, pulsing glow.

7. The method of claim 1 further comprising scrolling the page in a direction of the updated widget as indicated by the highlighted notification, and transitioning the highlighted notification to the updated widget as the updated widget appears in the viewable display area.

8. The method of claim 1 further comprising, where more than one widget is updated on the page, providing a highlighted notification for each updated widget.

9. The method of claim 8, further comprising overlaying elements of highlighted notifications for more than one updated widget in the same direction on the page.

10. The method of claim 8 wherein a different highlighted notification is provided for each updated widget.

11. An apparatus comprising:
at least one processor, the at least one processor being configured to:
detect, in a mobile communication device, an update to a widget on a content page, at least a portion of the content page being presented in a viewable display area of a screen of the device;
determine that the updated widget is not within the viewable display area of the screen of the device; and
provide a highlighted notification at an edge of the viewable display area, the edge of the viewable display area corresponding to a direction of the updated widget on the page.

12. The apparatus of claim 11, wherein the processor is further configured to determine that the updated widget is within the viewable display area of the screen, and provide the highlighted notification around a perimeter of the updated widget.

13. The apparatus of claim 11, wherein the processor is further configured to determine a dimension of the highlighted notification on the edge of the viewable display area to correspond to a respective dimension of a corresponding portion of the updated widget.

14. The apparatus of claim 11, wherein the processor is further configured to position the highlighted notification along the edge corresponding to a position of the updated widget on the page.

15. The apparatus of claim 11, wherein the processor is further configured to scroll the screen in the direction of the updated widget and transition the highlighted notification from the edge of the viewable display area to the updated widget when the updated widget is within the viewable display area.

16. The apparatus of claim 11, wherein the processor is further configured to provide the highlighted notification as a soft, pulsing glow.

17. The apparatus of claim 11, wherein the processor is further configured to, where more than one widget is updated on the page, provide a highlighted notification for each updated widget.

18. The apparatus of claim 17, wherein the processor is further configured to overlay elements of highlighted notifications for more than one updated widget in the same direction on the page.

19. A computer program product comprising a computer-readable medium bearing computer code embodied therein for use with a computer, the computer program code comprising:
code for detecting, in a mobile communication device, an update to a widget on a content page, at least a portion of the content page being presented in a viewable display area of a screen of the device;
code for determining that the updated widget is not within the viewable display area of the screen of the device; and
code for providing a highlighted notification at an edge of the viewable display area, the edge of the viewable display area corresponding to a direction of the updated widget on the page.

20. The computer program product of claim 18, the computer program code further comprising code for positioning the highlighted notification along the edge that corresponds to a position of the updated widget on the page.
